(19) United States
(12) Patent Application Publication
(10) Pub. No.: US 2013/0111380 A1
(43) Pub. Date: May 2, 2013

(54) DIGITAL WHITEBOARD IMPLEMENTATION

(71) Applicants: Michael Parker, Los Gatos, CA (US); Drew Fiero, Alameda, CA (US); Fernando Toledo, San Francisco, CA (US)

(72) Inventors: Michael Parker, Los Gatos, CA (US); Drew Fiero, Alameda, CA (US); Fernando Toledo, San Francisco, CA (US)

(73) Assignee: SYMANTEC CORPORATION, Mountain View, CA (US)

(21) Appl. No.: 12/895,571

(22) Filed: Sep. 30, 2010

Related U.S. Application Data
(60) Provisional application No. 61/320,642, filed on Apr. 2, 2010.
(60) Provisional application No. 61/322,796, filed on Apr. 9, 2010.

(51) Int. Cl. G06F 3/0482; G06F 3/0486

(52) U.S. Cl. CPC G06F 3/0482; G06F 3/0486
USPC 715/765; 715/769

(57) ABSTRACT

A computing system includes a touch screen display that can display a graphical user interface (GUI). The GUI includes a display region and a first plurality of GUI elements including a first GUI element associated with a tool. The tool is invoked when selection of the first GUI element is sensed by the touch screen display. The GUI also includes a second plurality of GUI elements including a second GUI element associated with a graphical object. The graphical object is displayed in the display region when selection of the second

GUI element is sensed by the touch screen display and the graphical object is dragged-and-dropped to a position within the display region.

### RELATED U.S. APPLICATIONS

This application claims priority to the U.S. Provisional Patent Application with Ser. No. 61/320,642 by M. Parker, filed on Apr. 2, 2010, entitled “Symantec Digital Whiteboard,” and to the U.S. Provisional Patent Application with Ser. No. 61/322,796 by M. Parker et al., filed on Apr. 9, 2010, entitled “Symantec Digital Whiteboard GUI Details,” both of which are hereby incorporated by reference in their entirety.

This application is related to the U.S. Patent Application by M. Parker et al., entitled “A Digital Whiteboard Implementation,” with Attorney Docket No. SYMT-S10-1031-US2, filed concurrently herewith.

### BACKGROUND

Whiteboards have become a ubiquitous feature in classrooms and meeting rooms. Whiteboards offer a number of advantages: they are easy to use, flexible, and visual. However, they also have a number of disadvantages.

For example, information written on a whiteboard may be nearly illegible, while drawings may be sloppy or amateurish. These problems are exacerbated if information written on the whiteboard is iterated upon—as information is erased and added, the whiteboard presentation may become difficult to read and follow.

Also, information captured on a whiteboard can be difficult to capture for future reference and use. A person may copy the material from a whiteboard presentation into handwritten notes, but such a record does not lend itself to future use. For example, the presentation will need to be redrawn on a whiteboard if discussion is to continue at a later meeting or at a meeting in a different location. Also, a handwritten copy of the whiteboard material is not easy to share with other people, especially those working remotely.

In general, conventional whiteboard presentations can be difficult to read and follow, cannot be easily captured (saved), may not accurately and completely capture meeting content, cannot be effectively or readily shared, and are difficult to iterate on, either during the initial meeting or at a later time.

Some of the issues described above are addressed by “virtual whiteboards” and other types of simulated whiteboards. However, a significant shortcoming of contemporary simulated whiteboards is that they do not allow a user to create new and substantive content on the fly.

### SUMMARY

According to embodiments of the present disclosure, a “digital whiteboard” as described herein provides a number of advantages over conventional whiteboards including conventional simulated whiteboards. In general, the digital whiteboard allows a user to create, control, and manipulate whiteboard presentations using touch screen capabilities. Preloaded images (graphical objects) are readily dropped-and-dragged into a display region (sometimes referred to as the whiteboard's canvas). The graphical objects can be manipulated and moved (e.g., rotated, moved to a different position, changed in size or color, etc.), and relationships between objects can be readily illustrated using other objects such as lines, arrows, and circles. As a result, visually appealing presentations are easily created. Furthermore, because the presentation is digital (in software), it can be readily iterated upon, saved, recreated, and shared (e.g., e-mailed or uploaded to a Web-accessible site). Because the presentation can be readily distributed and shared, collaboration among various contributors (even those separated by distance) is facilitated.

More specifically, in one embodiment, a computing system (e.g., a tablet computer system) includes a touch screen display that is mounted on the computing system itself (e.g., on a surface of the computing system's housing). In operation, a graphical user interface (GUI) is displayed on the touch screen display. The GUI includes a display region (a canvas), a first plurality of GUI elements (e.g., a toolbar) including a first GUI element associated with a first tool, and a second plurality of GUI elements (e.g., an object library) including a second GUI element associated with a graphical object. The first tool is invoked when selection of the first GUI element is sensed by the touch screen display. The graphical object is displayed in the display region when selection of the second GUI element is sensed by the touch screen display and the graphical object is dragged-and-dropped to a position within the display region.

The first tool is one of a variety of tools that can be used to perform operations such as, but not limited to: select; draw line; draw straight line; erase; create text; copy; paste; duplicate; group; ungroup; show grid; snap to grid; undo; redo; clear; scale; export image; save in an existing file; save as a new file; and open a file. In one embodiment, the create text tool, when invoked, causes a virtual keyboard to be displayed automatically on the touch screen display. In another embodiment, the draw line tool automatically groups graphical objects created between the time the tool is invoked (turned on) and the time the tool is turned off.

In one embodiment, a smart switching feature automatically switches from one tool to a different tool in response to a user input. For example, one tool may be switched off and another tool switched on when a selection of a GUI element in the second plurality of GUI elements (e.g., the object library) is sensed, or when a user input in the display region is sensed at an open or uncovered position (that is, a position that is not occupied by a graphical object).

In one embodiment, the GUI also includes a third GUI element associated with a properties tool for the computer graphics program. The properties tool can be used to affect a property of a graphical object, such as, but not limited to: line thickness; line color; type of line end (e.g., with or without an arrow head); font size; text style (e.g., normal, bold, or italics); text alignment; size of text box; type of border for text box; type (e.g., color) of background for text box; grid size; brightness; object name; and object software. In such an embodiment, the properties tool is invoked when selection of both the third GUI element and the graphical object of interest are sensed via the touch screen display.

In one embodiment, as part of the GUI, a first text field and a second text field are displayed on the touch screen display when selection of a graphical object is sensed by the touch screen display, and a virtual keyboard is displayed automatically on the touch screen display when selection of the first text field is sensed via the touch screen display. In one such embodiment, a third text field is displayed automatically on the touch screen display once a character is entered into the second text field. The text fields may include default text that is automatically entered when the field text field is generated; the default text is replaceable with text entered via the virtual keyboard.

In one embodiment, the second plurality of GUI elements (e.g., the object library) is customizable by adding and removing selected GUI elements. The second plurality of GUI elements may be a subset of a superset of GUI elements, where the superset of GUI elements is also customizable by importing GUI elements. Videos can also be imported, then called up and displayed as needed.

In one embodiment, graphical objects displayed in the display region are identified by names. In one such embodiment, a text-based version of the graphical objects that includes a list of the names and additional information can be generated. The additional information can include, but is not limited to, a price associated with each of the graphical objects, and a SKU (stock-keeping unit) associated with each of the graphical objects. Using this feature, an invoice or purchase order can be automatically created based on the material included in the digital whiteboard presentation.

In one embodiment, the touch screen display is a multi-touch screen display. Accordingly, an action such as, but not limited to, scrolling, pinch zoom, zoom in, and zoom out can be invoked in response to the touch screen display sensing contact at multiple points concurrently.

In summary, a digital whiteboard having some or all of the features described above can be used to create on the fly presentations that are easy to read and follow, can be easily captured (saved), can capture meeting content accurately and completely, can be effectively and readily shared, and are easy to iterate on, either during the initial meeting or at a later time.

These and other objects and advantages of the various embodiments of the present disclosure will be recognized by those of ordinary skill in the art after reading the following detailed description of the embodiments that are illustrated in the various drawing figures.

### BRIEF DESCRIPTION OF THE DRAWINGS

The accompanying drawings, which are incorporated in and form a part of this specification and in which like numerals depict like elements, illustrate embodiments of the present disclosure and, together with the description, serve to explain the principles of the disclosure.

FIG. 1A is a block diagram of an example of a computing system upon which embodiments of the present disclosure can be implemented.

FIG. 1B is a perspective drawing illustrating an example of a computing system upon which embodiments of the present disclosure can be implemented.

FIG. 2 is an example of a graphical user interface (GUI) rendered on display according to an embodiment of the present disclosure.

FIG. 3 is an example of a GUI toolbar rendered on a display according to an embodiment of the present disclosure.

FIG. 4 is an example of the use of an onscreen GUI tool according to an embodiment of the present disclosure.

FIG. 5 is an example of the use of another an onscreen GUI tool according to an embodiment of the present disclosure.

FIGS. 6A, 6B, and 6C illustrate an object grouping feature according to an embodiment of the present disclosure.

FIG. 7 is an example of onscreen GUI navigation controls according to an embodiment of the present disclosure.

FIG. 8 is an example of an onscreen GUI panel displaying a library of graphical objects according to an embodiment of the present disclosure.

FIG. 9 is an example of an onscreen GUI for managing libraries of graphical objects according to an embodiment of the present disclosure.

FIGS. 10A, 10B, and 100 illustrate a tool-switching feature according to an embodiment of the present disclosure.

FIGS. 11A, 11B, 11C, 11D, and 11E illustrate a graphical object labeling feature according to an embodiment of the present disclosure.

FIG. 12 illustrates a flowchart of a computer-implemented method for implementing a GUI according to embodiments of the present disclosure.

### DETAILED DESCRIPTION

Reference will now be made in detail to the various embodiments of the present disclosure, examples of which are illustrated in the accompanying drawings. While described in conjunction with these embodiments, it will be understood that they are not intended to limit the disclosure to these embodiments. On the contrary, the disclosure is intended to cover alternatives, modifications and equivalents, which may be included within the spirit and scope of the disclosure as defined by the appended claims. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

Some portions of the detailed descriptions that follow are presented in terms of procedures, logic blocks, processing, and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those utilizing physical manipulations of physical quantities. Usually, although not necessarily, these quantities take the form of electrical or magnetic signals capable of being stored, transferred, combined, compared, and otherwise manipulated in a computing system. It has proven convenient at times, principally for reasons of common usage, to refer to these signals as transactions, bits, values, elements, symbols, characters, samples, pixels, or the like.

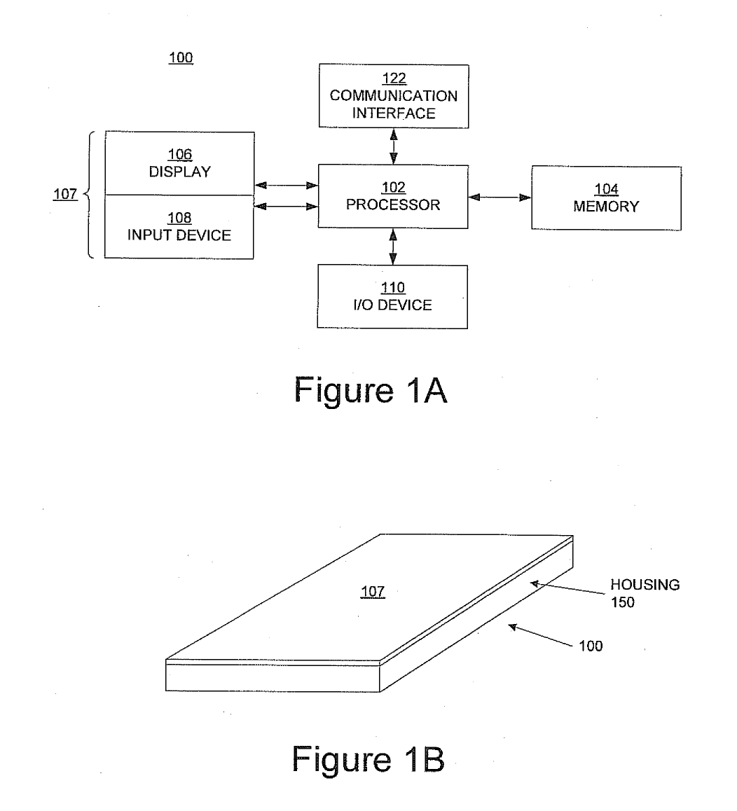

It should be borne in mind, however, that all of these and similar terms are to be associated with the appropriate physical quantities and are merely convenient labels applied to these quantities. Unless specifically stated otherwise as apparent from the following discussions, it is appreciated that throughout the present disclosure, discussions utilizing terms such as “sensing,” “communicating,” “generating,” “invoking,” “displaying,” “switching,” or the like, refer to actions and processes (e.g., flowchart 1200 of FIG. 12) of a computing system or similar electronic computing device or processor (e.g., system 100 of FIG. 1A). The computing system or similar electronic computing device manipulates and transforms data represented as physical (electronic) quantities within the computing system memories, registers or other such information storage, transmission or display devices.

Embodiments described herein may be discussed in the general context of computer-executable instructions residing on some form of computer-readable storage medium, such as program modules, executed by one or more computers or other devices. By way of example, and not limitation, computer-readable storage media may comprise non-transitory computer-readable storage media and communication media; non-transitory computer-readable media include all computer-readable media except for a transitory, propagating signal. Generally, program modules include routines, programs, objects, components, data structures, etc., that perform particular tasks or implement particular abstract data types. The functionality of the program modules may be combined or distributed as desired in various embodiments.

Computer storage media includes volatile and nonvolatile, removable and non-removable media implemented in any method or technology for storage of information such as computer-readable instructions, data structures, program modules or other data. Computer storage media includes, but is not limited to, random access memory (RAM), read only memory (ROM), electrically erasable programmable ROM (EEPROM), flash memory or other memory technology, compact disk ROM (CD-ROM), digital versatile disks (DVDs) or other optical storage, magnetic cassettes, magnetic tape, magnetic disk storage or other magnetic storage devices, or any other medium that can be used to store the desired information and that can accessed to retrieve that information.

Communication media can embody computer-executable instructions, data structures, and program modules, and includes any information delivery media. By way of example, and not limitation, communication media includes wired media such as a wired network or direct-wired connection, and wireless media such as acoustic, radio frequency (RF), infrared and other wireless media. Combinations of any of the above can also be included within the scope of computer-readable media.

FIG. 1A is a block diagram of an example of a computing system 100 capable of implementing embodiments of the present disclosure. Computing system 100 broadly represents any single or multi-processor computing device or system capable of executing computer-readable instructions. Examples of computing system 100 include, without limitation, a laptop, tablet, or handheld computer. Computing system 100 may also be a type of computing device such as a cell phone, smart phone, media player, or the like.

In its most basic configuration, computing system 100 may include at least one processor 102 and at least one memory 104. Processor 102 generally represents any type or form of processing unit capable of processing data or interpreting and executing instructions. In certain embodiments, processor 102 may receive instructions from a software application or module (e.g., a digital whiteboard computer graphics program). These instructions may cause processor 102 to perform the functions of one or more of the example embodiments described and/or illustrated herein.

Memory 104 generally represents any type or form of volatile or non-volatile storage device or medium capable of storing data and/or other computer-readable instructions. Examples of memory 104 include, without limitation, RAM, ROM, flash memory, or any other suitable memory device. Although not required, in certain embodiments computing system 100 may include both a volatile memory unit (such as, for example, memory 104) and a non-volatile storage device (not shown).

Computing system 100 also includes a display device 106 that is operatively coupled to processor 102. Display device 106 may be, for example, a liquid crystal display (LCD). Display device 106 is generally configured to display a graphical user interface (GUI) that provides an easy to use interface between a user and the computing system. A GUI according to embodiments of the present disclosure is described in greater detail below.

Computing system 100 also includes an input device 108 that is operatively coupled to processor 102. Input device 108 may include a touch sensing device (a touch screen) configured to receive input from a user's touch and to send this information to the processor 102. In general, the touch-sensing device recognizes touches as well as the position and magnitude of touches on a touch sensitive surface. Processor 102 interprets the touches in accordance with its programming. For example, processor 102 may initiate a task in accordance with a particular position of a touch. The touch-sensing device may be based on sensing technologies including, but not limited to, capacitive sensing, resistive sensing, surface acoustic wave sensing, pressure sensing, optical sensing, and/or the like. Furthermore, the touch sensing device may be capable of single point sensing and/or multipoint sensing. Single point sensing is capable of distinguishing a single touch, while multipoint sensing is capable of distinguishing multiple touches that occur concurrently.

Input device 108 may be integrated with display device 106 or they may be separate components. In the illustrated embodiment, input device 108 is a touch screen that is positioned over or in front of display device 106. Input device 108 and display device 106 may be collectively referred to herein as touch screen display 107.

With reference to FIG. 1 B, in one embodiment, touch screen display 107 is mounted on a surface of computing system 100. That is, the internal components (e.g., processor 102 and memory 104) of computing device 100 are typically enclosed within some type of housing 150, and touch screen display 107 is mounted on or forms one surface of that housing.

Communication interface 122 of FIG. 1A broadly represents any type or form of communication device or adapter capable of facilitating communication between example computing system 100 and one or more additional devices. For example, communication interface 122 may facilitate communication between computing system 100 and a private or public network including additional computing systems. Examples of communication interface 122 include, without limitation, a wired network interface (such as a network interface card), a wireless network interface (such as a wireless network interface card), a modem, and any other suitable interface. In one embodiment, communication interface 122 provides a direct connection to a remote server via a direct link to a network, such as the Internet. Communication interface 122 may also indirectly provide such a connection through any other suitable connection.

Communication interface 122 may also represent a host adapter configured to facilitate communication between computing system 100 and one or more additional network or storage devices via an external bus or communications channel. Examples of host adapters include, without limitation, Small Computer System Interface (SCSI) host adapters, Universal Serial Bus (USB) host adapters, IEEE (Institute of Electrical and Electronics Engineers) 1394 host adapters, Serial Advanced Technology Attachment (SATA) and External SATA (eSATA) host adapters, Advanced Technology Attachment (ATA) and Parallel ATA (PATA) host adapters, Fibre Channel interface adapters, Ethernet adapters, or the like. Communication interface 122 may also allow computing system 100 to engage in distributed or remote computing. For example, communication interface 122 may receive instructions from a remote device or send instructions to a remote device for execution.

As illustrated in FIG. 1A, computing system 100 may also include at least one input/output (I/O) device 110. I/O device 110 generally represents any type or form of input device capable of providing/receiving input or output, either computer- or human-generated, to/from computing system 100. Examples of I/O device 110 include, without limitation, a keyboard, a pointing or cursor control device (e.g., a mouse), a speech recognition device, or any other input device.

Many other devices or subsystems may be connected to computing system 100. Conversely, all of the components and devices illustrated in FIG. 1A need not be present to practice the embodiments described herein. The devices and subsystems referenced above may also be interconnected in different ways from that shown in FIG. 1A. Computing system 100 may also employ any number of software, firmware, and/or hardware configurations. For example, the example embodiments disclosed herein may be encoded as a computer program (also referred to as computer software, software applications, computer-readable instructions, or computer control logic) on a computer-readable medium.

The computer-readable medium containing the computer program may be loaded into computing system 100. All or a portion of the computer program stored on the computer-readable medium may then be stored in memory 104. When executed by processor 102, a computer program loaded into computing system 100 may cause processor 102 to perform and/or be a means for performing the functions of the example embodiments described and/or illustrated herein. Additionally or alternatively, the example embodiments described and/or illustrated herein may be implemented in firmware and/or hardware.

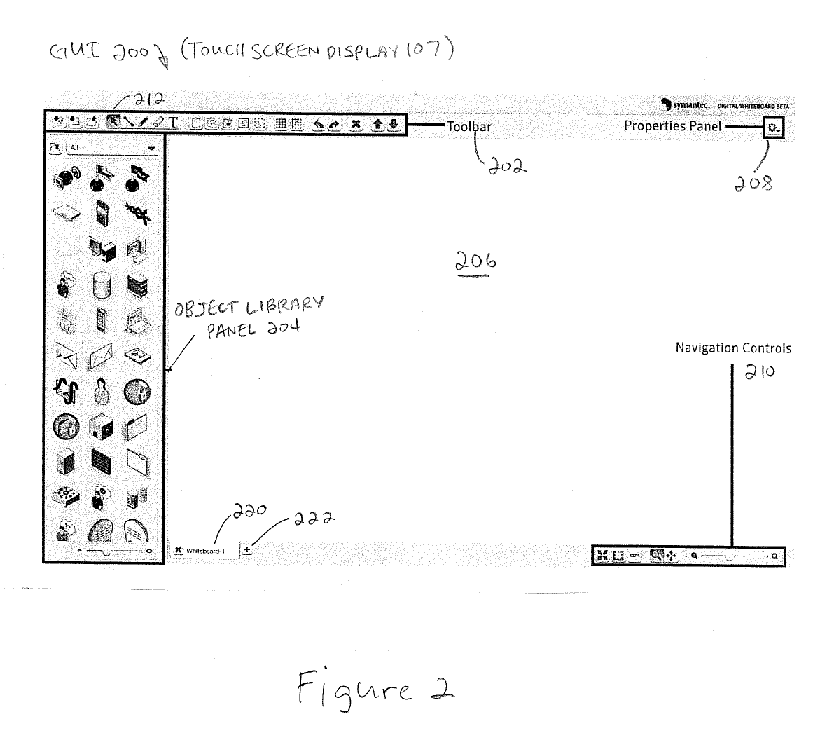

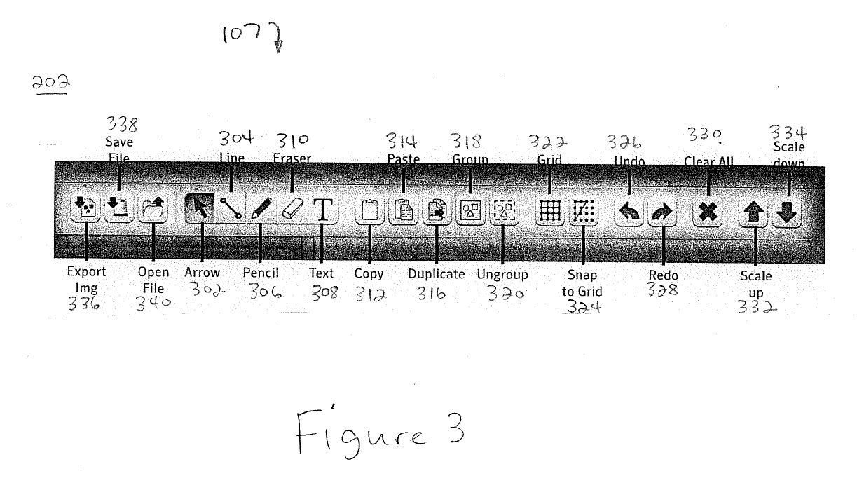

FIG. 2 is an example of a GUI 200 rendered on touch screen display 107 according to an embodiment of the present disclosure. In the example of FIG. 2, GUI 200 includes toolbar 202, object library panel 204, display region (canvas) 206, properties panel 208, and navigation controls 210.

Toolbar 202 may be referred to herein as the first plurality of GUI elements. In general, toolbar 202 includes individual GUI elements (exemplified by GUI element 212, which may also be referred to herein as the first GUI element). Each GUI element in toolbar 202 is associated with a respective tool or operation. When a user touches GUI element 212, for example—specifically, when the selection of GUI element 212 is sensed by touch screen display 107—then the tool associated with that GUI element is invoked. Any tool can be automatically deselected by invoking (selecting) another tool on toolbar 202.

A variety of tools can be included in toolbar 202 to perform operations such as, but not limited to: select; draw line; draw straight line; erase; create text; copy; paste; duplicate; group; ungroup; show grid; snap to grid; undo; redo; clear; scale; export image; save in an existing file; save as a new file; and open a file.

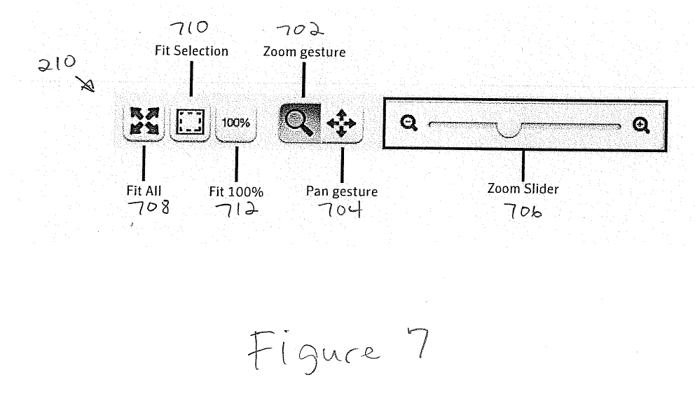

With reference to FIG. 3, user-controlled arrow tool 302 is selected by a user when the user touches the GUI element for arrow tool 302 and that touch is sensed by touch screen display 107. When arrow tool 302 is selected (invoked or active), a user can also select a graphical object in display region 206 (FIG. 2) by touching the object with a finger. Also, when arrow tool 302 is invoked, a user can drag that graphical object to a different position by maintaining finger contact with the rendered object while moving the finger, and hence the object, along the surface of touch screen display 107. Also, when arrow tool 302 is selected, a user can select a different graphical object from object library panel 204 and drag-and drop that object into display region 206. With arrow tool 302 selected, a user can also scale up or scale down a selected object or can “pinch zoom,” which is discussed in conjunction with FIG. 7, below.

Continuing with reference to FIG. 3, when straight line tool 304 is selected by a user, the user can create a straight line by touching display region 206 with a finger and then dragging the finger across the display region. Once straight line tool 304 is invoked, if the user then touches a graphical object with a finger and then creates a straight line as described above, then that line will be linked (grouped) with the graphical object—if the object is moved, the line will move with it. Similarly, once the user uses straight line tool 304 to draw a straight line between two ungrouped graphical objects (by touching one of the objects and then dragging the finger to the other object while the tool is invoked), if one of the objects is later moved then the end of the line connected to that object line will also move, while the other end of the line will remain connected to the second (stationary) object. If the two objects are grouped and one of the objects is moved, then the other object and a line between the objects will also move.

In one embodiment, if a user subsequently selects a rendered line, then a line properties panel (not shown) is automatically displayed. The line properties panel can be used, for example, to change the color and/or thickness of the line, and/or to add or remove an arrow head at either or both ends of the line.

Pencil tool 306, also referred to herein as a draw line tool, can be used to draw a graphical object in a free-hand manner. With pencil tool 306 selected, a new drawing object is started when the user touches display region 206 (FIG. 2). In one embodiment, when pencil tool 306 is selected, a done “button” (a GUI element) is automatically rendered in display region 206. The user can continue drawing until pencil tool 306 is again selected (toggled off), or until the done button is touched, or until a different tool is selected from toolbar 202. In one embodiment, all of the individual drawing objects created between the time the pencil tool 306 is invoked and the time it is no longer invoked are automatically linked to one another (grouped) so that they can be manipulated (e.g., moved, scaled, rotated, etc.) as a single graphical object.

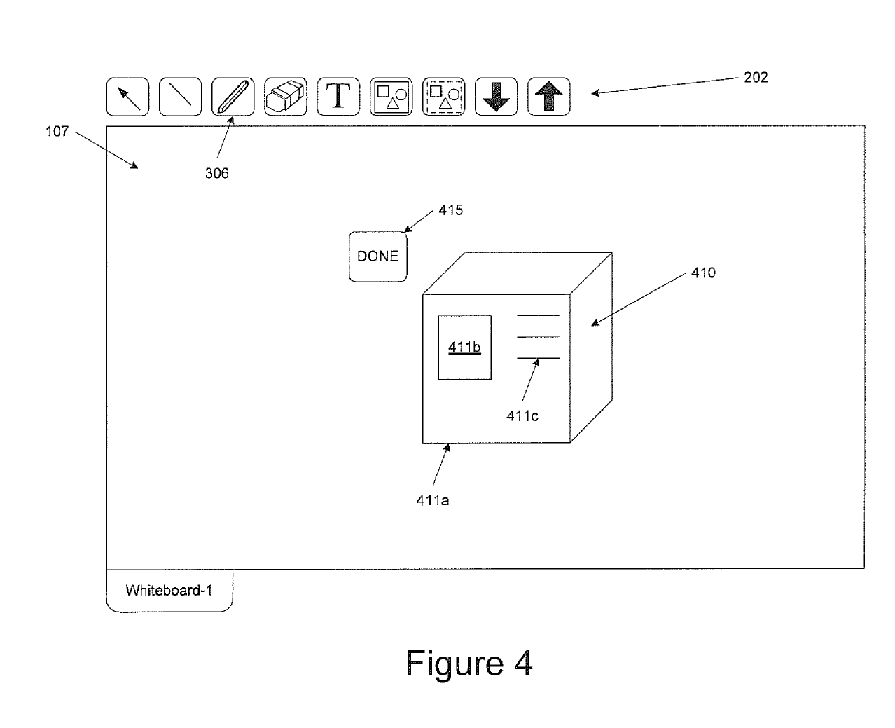

FIG. 4 illustrates an example of pencil tool 306 in use. With pencil tool 306 selected in toolbar 202, a user can hand-draw elements 411a, 411b, and 411c, for instance, to create graphical object 410. Done button 415 is automatically displayed when pencil tool 306 is selected. As mentioned above, when the done button is selected, the elements 411a, 411b, and 411c are automatically grouped, so that graphical object 410 can be manipulated as a single object. Different graphical objects can be created by drawing the elements that constitute one object, then touching done button 415 (which groups those objects), drawing the elements that constitute a second object, again touching the done button, and so on.

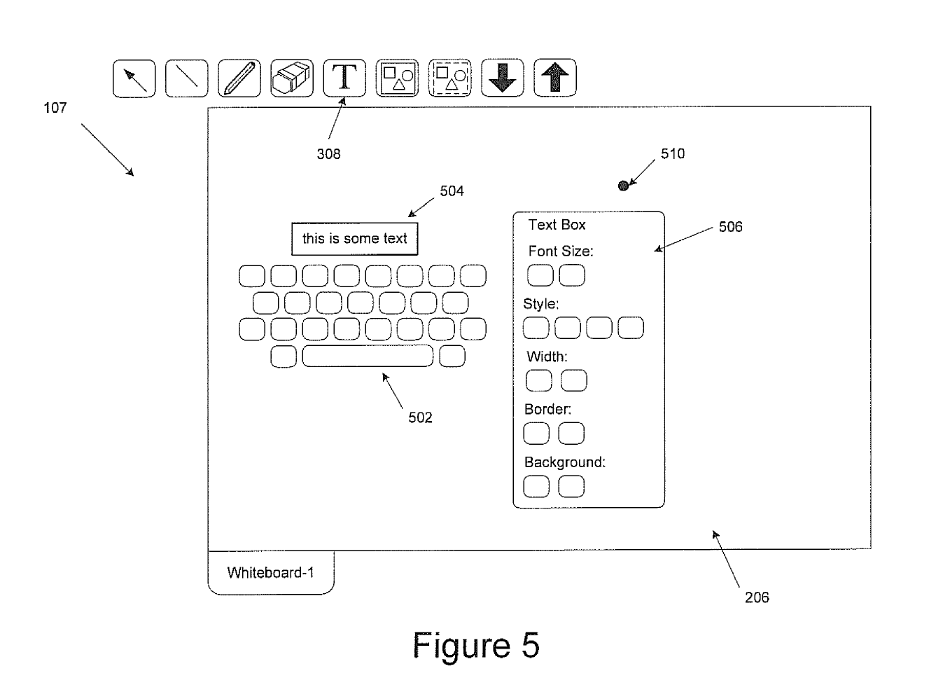

With reference to FIG. 5, create text tool 308, when invoked, causes virtual keyboard 502 and text box 504 to be displayed automatically on touch screen display 107. Virtual keyboard 502 and text box 504 can be moved within display region 206 (FIG. 2) like any other graphical object. Virtual keyboard 502 can be used to enter text into text box 504. In one embodiment, text tool panel 506 is also displayed automatically. Text tool panel 506 includes elements that can be used to affect the characteristics of the text entered into text box 504 or to affect the characteristics of the text box itself. For example, the font size of the text can be set, a style of text can be selected (e.g., normal, bold, or italics), the size of the text box can be changed, or a border or background color can be added to the text box. In one embodiment, when the user touches a location (e.g., point 510) in display region 206 that is not covered by virtual keyboard 502, text box 504, or text tool panel 506, then create text tool 308 is automatically deselected, causing the virtual keyboard and text tool region to disappear. In one embodiment, virtual keyboard 502 includes a done button similar in function to that described above; by touching the done button on the virtual keyboard, text box 504 becomes a graphical object like other graphical objects. Also, in one embodiment, a default tool—such as arrow tool 302—is automatically selected when create text tool 308 is deselected.

In general, a user selects a graphical object by touching it, and that graphical object remains selected until the user touches an unoccupied location (e.g., point 510) in display region 206.

With reference again to FIG. 3, eraser tool 310 can be used to delete graphical objects from display region 206 (FIG. 2) or to erase part of a drawing. To erase, a user first selects the item to be erased by touching it, and then selects (touches) eraser tool 310. Instead of first selecting an item to be erased, a user can select eraser tool 310; any item then touched by the user will be deleted as long as the eraser tool remains selected. Furthermore, while in drawing mode using pencil tool 306, eraser tool 310 can serve as a digital eraser; a user can touch and drag any part of a drawing and that part will be erased.

Copy tool 312 can be used to copy anything (e.g., text, one or more graphical objects including text boxes, drawings, and lines, etc.) onto a clipboard for later use. Paste tool 314 can be used to paste information in the clipboard into display region 206. Duplicate tool 316 can be used to instantly copy and paste a current selection (e.g., text, one or more graphical objects including text boxes, drawings, and lines, etc.).

Group tool 318 and ungroup tool 320 can be used to group (link) a current selection of graphical objects and to ungroup a previously created group of objects, respectively. If rendered objects are grouped, then when one object in the group is selected, all objects in the group are selected. If one object in a group is moved, then all objects in the group are moved by the same amount and in the same direction so that the spatial relationship between the objects is maintained.

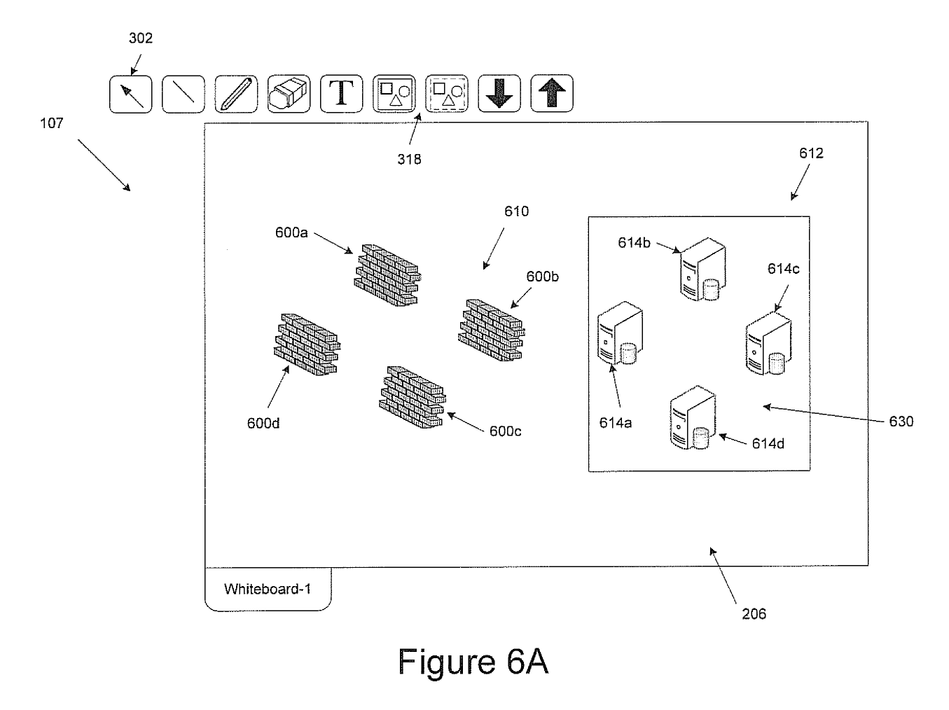

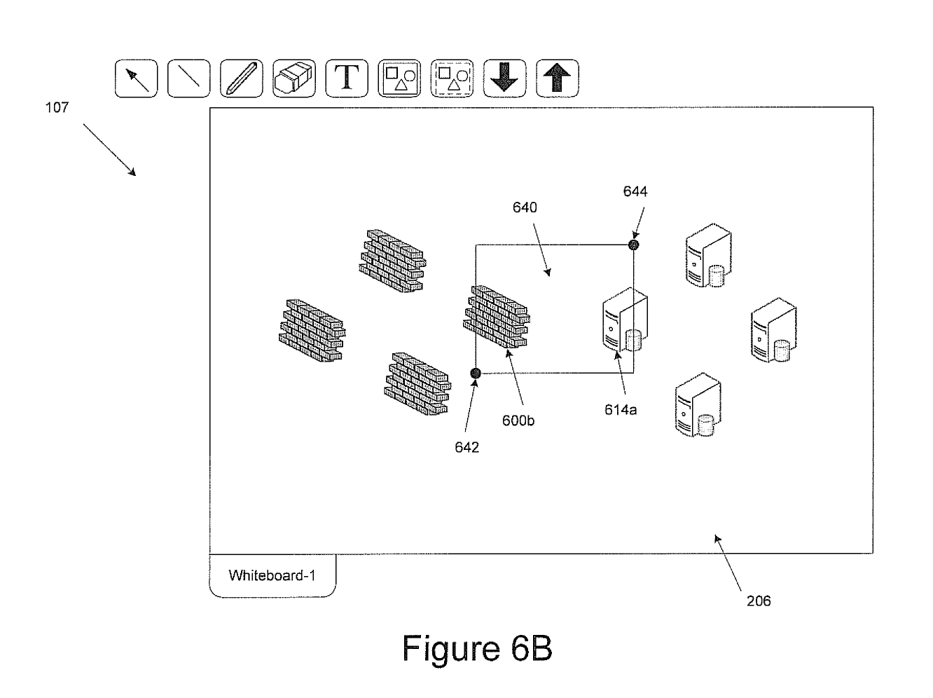

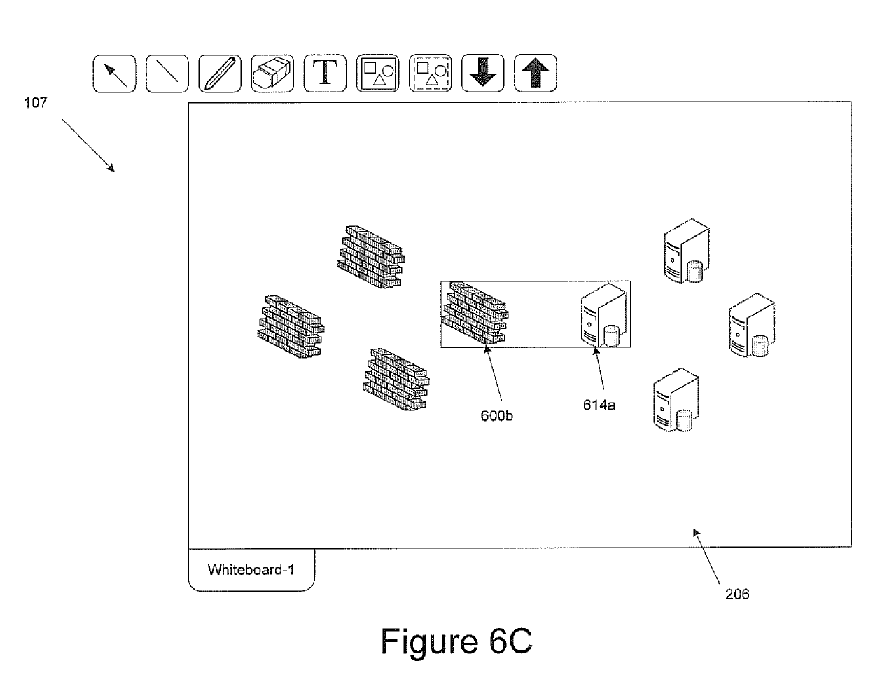

FIGS. 6A, 6B, and 6C illustrate an object grouping feature according to an embodiment of the present disclosure. In the example of FIG. 6A, a user has defined two groups of graphical objects using group tool 318. More specifically, in one embodiment, with arrow tool 302 invoked, the user can select (highlight) graphical objects 600a-600d by touching each of those objects or by dragging his or her finger across the touch screen display 107 to create a temporary region that encompasses those objects (see FIGS. 6B and 6C). With graphical objects 600a-600d highlighted in this manner, the user can then select group tool 318 to group those objects into first group 610. In a similar manner, graphical objects 614a-614d can be grouped into second group 612.

As shown in FIG. 6A, when the user touches one of the graphical objects in a group (e.g., the user touches object 614a in second group 612), the entire group is selected and highlighted by group perimeter element 630. Once a group is selected in this fashion, the entire group can be manipulated (e.g., moved, scaled, etc.) as a single entity.

FIG. 6B illustrates a drag select operation in which the user places a finger at point 642, for example, and then drags the finger to point 644 to form region 640 that encompasses (or at least touches) graphical objects 600b and 614a. This causes graphical objects 600b and 614a to be selected into a temporary group (see FIG. 6C) that can be manipulated as a single entity without affecting the other graphical objects in the first and second groups. In other words, graphical objects 600b and 614a can be moved, scaled, etc., without affecting graphical objects 600a, 600c, 600d, and 614b-614d. Once the temporary group is deselected, the original group assignments (as shown in FIG. 6A) are automatically restored.

With reference back to FIG. 3, grid tool 322 can be used to toggle on and off a visible grid that helps a user better align rendered objects. For even more precision, snap to grid tool 324 can be used to automatically place an object at a grid intersection.

In one embodiment, each user action is recorded and maintained in chronological order in a list. Undo tool 326 can be used to undo the latest action taken by a user, and redo tool 328 can be used to move forward to the next recorded action.

Clear all tool 330 can be used to clear (delete) all rendered objects from display region 206. Scale up tool 332 and scale down tool 334 are used to increase or decrease the size of a selected graphical object or group of objects.

Export image tool 336, when selected, prompts a user to select a type of image file to export (e.g., .png or .jpg) and then to select a location to save that image file. In one embodiment, the exported image file contains the current version of the digital whiteboard presentation (e.g., it includes only display region 206).

Save file tool 338, when selected, prompts a user to save the selected digital whiteboard presentation (e.g., display region 206) into a file of the file type associated with the digital whiteboard computer graphics program (e.g., a file with an extension specific to the digital whiteboard program). Open file tool 340, when selected, prompts a user to browse for files associated with the digital whiteboard program (e.g., files with the program-specific extension). When a particular file of interest is selected, open file tool 340 will prompt the user to open the file or to merge the file with another open file.

An advantage to the disclosed digital whiteboard is that the size of display region 206 (FIG. 2) is infinite. Consequently, a user will not run out of writing and drawing space. Also, a user can move graphical objects out of the way (to another part of display region 206) in order to diagram something different and can come back to them later.

With reference to FIG. 7, navigation controls 210 are provided to help a user navigate within display region 206 (FIG. 2). When the arrow tool 302 (FIG. 3) is active (selected), either zoom gesture element 702 or pan gesture element 704 can also be selected. If zoom gesture element 702 is selected, a user can pinch zoom anywhere in display region 206 to zoom in or zoom out from the center of touch screen display 107 (FIG. 1A). To pinch zoom, a user touches touch screen display 107 with two fingers and then, while maintaining contact with the touch screen, moves the two fingers further apart from one another to zoom out, or moves the two fingers closer together to zoom in. Zoom slider 706 can be used instead of the pinch zoom gesture to zoom in or out by moving the virtual slider element in one direction or the other.

If pan gesture element 704 is selected, a user can scroll (pan) around display region 206 by placing two fingers on touch screen display 107 and then moving both fingers in any direction while maintaining contact with the touch screen, thereby bringing a different part of the display region 206 into view.

Fit all element 708 and fit selection element 710 allow a user to quickly position display region 206 and zoom to fit either all graphic objects or a selected portion of those objects into the visible region. Fit 100% size element 712 can be used to resize display region 206 to its original size regardless of how many graphical objects are selected.

With reference back to FIG. 2, object library panel 204 may be referred to herein as the second plurality of GUI elements. Object library panel 204 includes individual GUI elements corresponding to respective graphical objects; the object library panel is where the library of objects (e.g., icons and stencils) available to a user is stored. In order to add a particular graphical object to a digital whiteboard presentation, a user can touch (select) the GUI element associated with that object, then drag-and-drop the selected object into display region 206. Graphical objects can be static (still images) or moving (animated images, or videos). In one embodiment, the GUI elements in object library panel 204 all relate to components of product lines particular to an enterprise; for example, all the GUI elements might relate to servers, firewalls, and other network-related components for an enterprise that specializes in such products.

Additional graphical objects can be imported into the library of objects so that the number of objects in the library can be expanded. Furthermore, as will be seen, customized subsets of the library of objects can be created so that a user can organize the library in a manner in line with his or her preferences. For ease of discussion, the superset of objects may be referred to herein as the main library, and customizable subsets of the main library may be referred to simply as libraries.

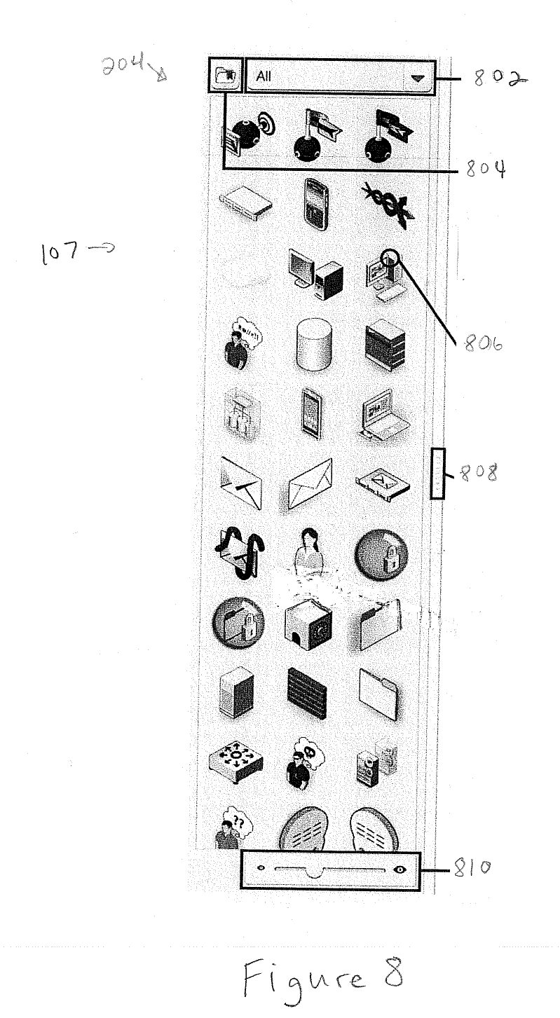

With reference to FIG. 8, filtering drop-down menu 802 is used to select a specific library to load, including the main library (all libraries), into library object panel 204. A user selects (touches) an entry in menu 802 to select a specific library or to select all libraries. Library manager element 804 can be used to display a library manager, which is described further in conjunction with FIG. 9.

To instantiate a graphical object in the digital whiteboard presentation, a user touches the corresponding GUI element (icon) in the library object panel (e.g., GUI element 806), drags that object/icon to display region 206 (FIG. 2) by keeping his or her finger in contact with touch screen display 107 (FIG. 1A), and drops the object anywhere in the display region by lifting the finger from the touch screen display.

Continuing with reference to FIG. 8, width grabber element 808 can be used to resize library object panel 204 to accommodate more GUI elements. Width grabber element 808 can also be used to hide library object panel 204 to increase the size of the displayed portion of display region 206. To resize library object panel 204, width grabber element 808 is touched and then dragged to the left or right; to hide the panel, the user taps the width grabber element. Also, a user can scroll and pan through library object panel 204 using the two-finger techniques described above.

Slider element 810 can be used to enlarge or shrink the size of the GUI elements displayed in library object panel 204 so that the panel can fit less or more elements. Slider element 810 can also be used to define the initial size of a graphical object when that object is dropped into display region 206 of FIG. 2. In other words, the size of a graphical object can be scaled once it is added to display region 206 using the techniques described above, or it can be scaled before it is added to the display region using slider element 810.

With reference now to FIG. 9, library manager panel 900 can be used to organize the main library into subsets and to import new graphical objects. Library manager panel 900 includes list 902 of the different libraries available to a user. Each library can be identified by a unique, user-specified name. The features of library manager panel 900 are described further by way of the following examples.

To modify an existing library, the user selects (touches) the name of that library in list 902. In the example of FIG. 9, the library named “Security” is selected, as shown in window 908. The main library of graphical objects (icons) is displayed in panel 910, and the graphical objects in the selected library (Security) are displayed in panel 912. A user can add a graphical object to the selected library by dragging-and-dropping the object from panel 910 into panel 912. A user can remove a graphical object from the selected library by dragging it outside panel 912. Graphical objects in a library can be reordered by dragging-and-dropping the object into a different position within the panel.

A user can change the name of the library shown in window 908 by touching the window, which causes a virtual keyboard (previously described herein) to be displayed. The library named in window 908 can be duplicated using GUI element 914; the duplicate library can then be modified by adding or removing GUI elements. The library named in window 908 can be made the default library using GUI element 916 (otherwise, the main library is made the default library).

Panel 910 includes search window 920 so that graphical objects can be found without scrolling. A user can touch window 920 to display a virtual keyboard that can be used to type a keyword into that window. Graphical objects with identifiers that match the keyword will then be displayed in panel 910.

GUI element 924 can be used to import graphical objects into the main library, and GUI element 922 can be used to remove imported graphical objects from the main library. When a user touches GUI element 924, the user is prompted to select a file (e.g., a .png, .jpg, or .swf file) to be imported into the main library. In one embodiment, if a user selects only a single file, then that file/graphical object will be imported into the main library, but if a user selects multiple files, then a new library will be automatically created. To delete an imported graphical object from the main library, the object is selected and then dragged to GUI element 922.

To create a new library, GUI element 904 is touched. For a new library, panel 912 will be initially empty; GUI elements can be added to panel 912 as described above, and the new library can be named by entering a name into window 908 using the virtual keyboard. A GUI element can be removed from panel 912 by dragging-and-dropping that element to a position outside of the panel. To delete an existing library, the user selects (touches) the name of that library in list 902 and then touches GUI element 906. As mentioned above, a user can make the new library the default library by touching GUI element 916.

The GUI element 926 is used to restore libraries to their default settings, and the GUI element 928 is used to commit changes and exit library manager panel 900.

With reference back to FIG. 2, to create a digital whiteboard presentation, a user touches GUI element 222 to create a new tab 220. Preloaded graphical objects, hand-drawn objects, labels, text boxes, etc., are added to display region 206, connected by lines, and grouped using the techniques and tools described above. The resulting digital whiteboard presentation can be saved using save file tool 338 or exported using export image tool 336 (FIG. 3) as mentioned above. Additional digital whiteboards can be created by opening new tabs.

A previously created and saved digital whiteboard presentation can be retrieved using open file tool 340 (FIG. 3). The retrieved file can be resaved to capture changes and iterations, or can be saved as a different file. Thus, for example, a presentation template can be created and saved, and then later modified and saved as a different file in order to preserve the original state of the template.

A “relink” feature is used to address the situation in which a digital whiteboard presentation is created and saved using one version of the digital whiteboard computer graphics program but is reopened with a different version of the program. In such a situation, a graphical object in the version used to create the whiteboard presentation may not be available in the library of another version because, for example, one user imported the graphical object but other users have not. Consequently, when the whiteboard presentation is reopened using a different version of the program, a generic icon such as a blank box will appear in the whiteboard presentation where the graphical object should appear. With the relink feature, a user can touch the generic icon to get the name of the graphical object that should have been displayed, and then can use that name to find the current or a comparable version of that graphical object, or at least a suitable version of that object, using search window 920 (FIG. 9), for example.

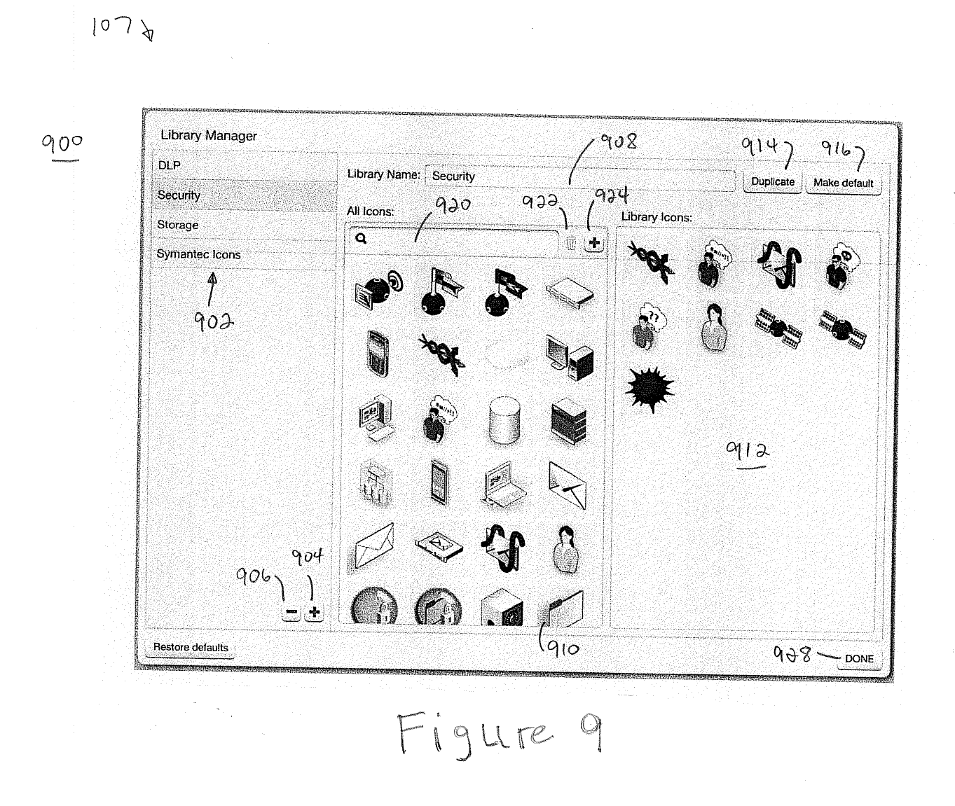

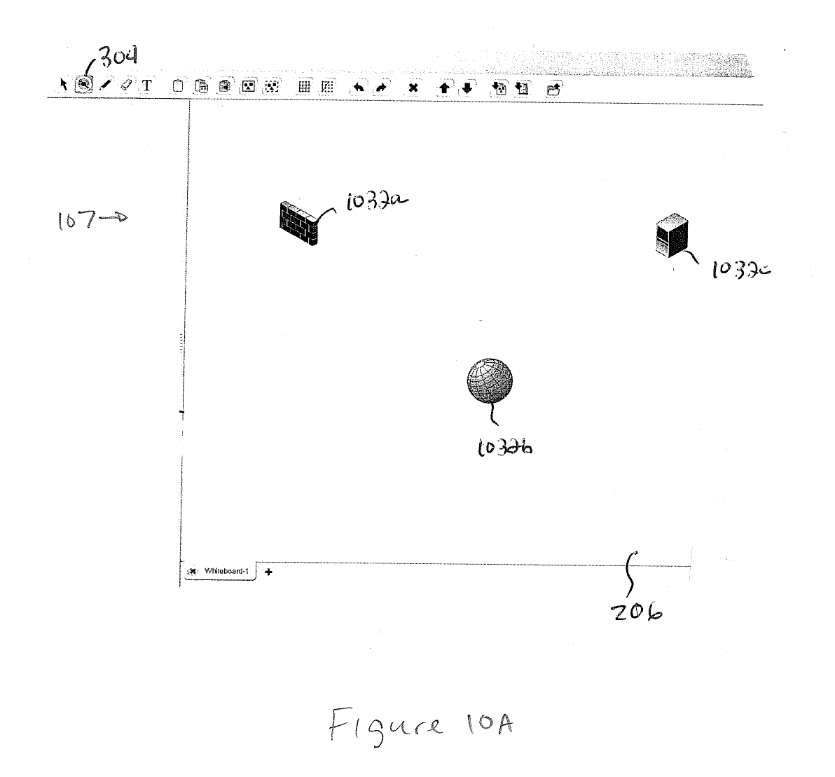

FIGS. 10A, 10B, and 10C illustrate a tool-switching feature according to an embodiment of the present disclosure. In FIG. 10A, graphical objects 1032a, 1032b, and 1032c are instantiated in display region 206. In FIG. 10B, lines 1036a and 1036b are drawn using straight line tool 304 (FIG. 3); thus, at this point, the straight line tool is active. In FIG. 10C, the user selects GUI element 1040 in object library panel 204 and drags-and-drops the corresponding graphical object 1042 into display region 206 (FIG. 2). As a result of this action, the digital whiteboard program automatically switches from the straight line tool to arrow tool 302. In general, the digital whiteboard program can automatically switch from one tool to another without the user interacting with toolbar 202.

In a similar manner, a default tool can be invoked when a tool is deselected. For example, as described above, when create text tool 308 is deselected, arrow tool 302 is automatically invoked.

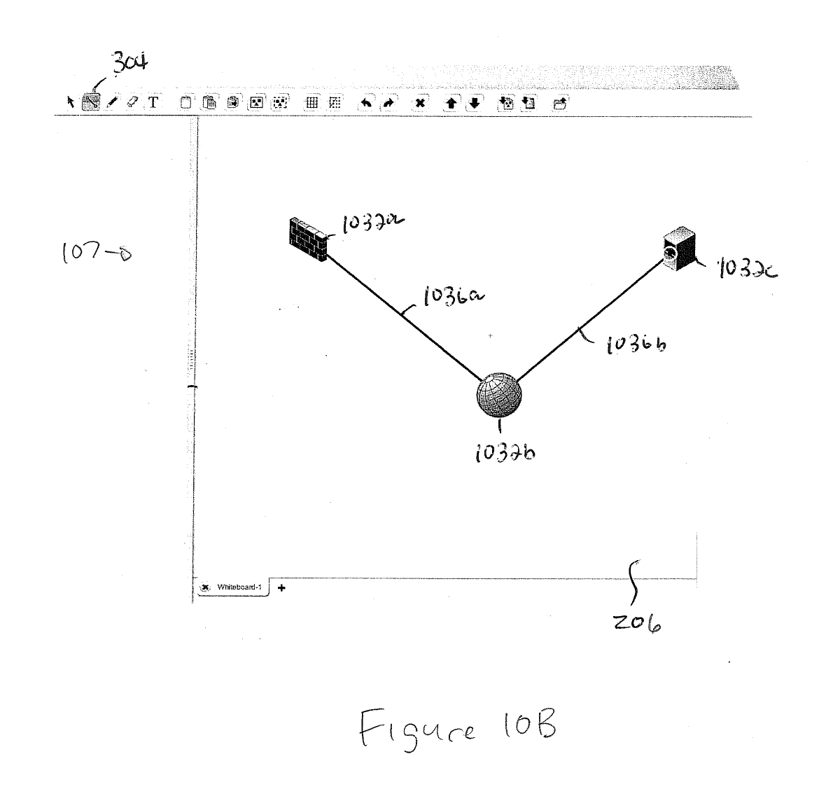

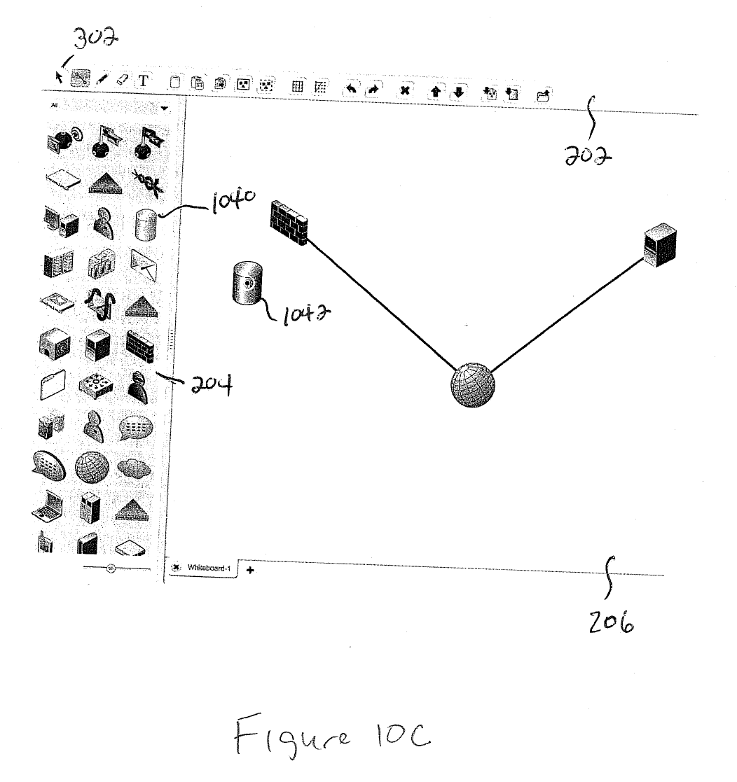

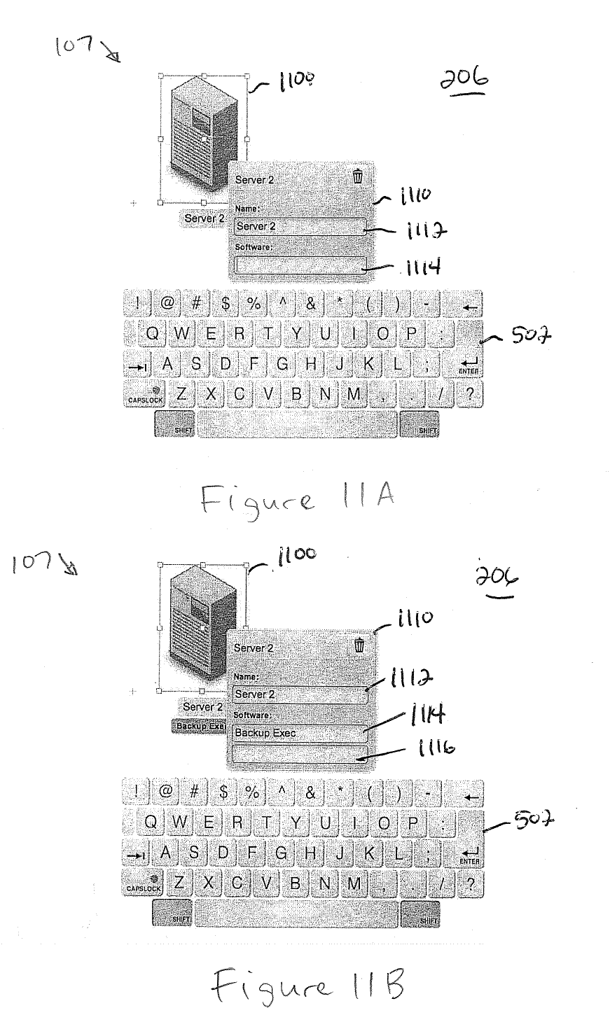

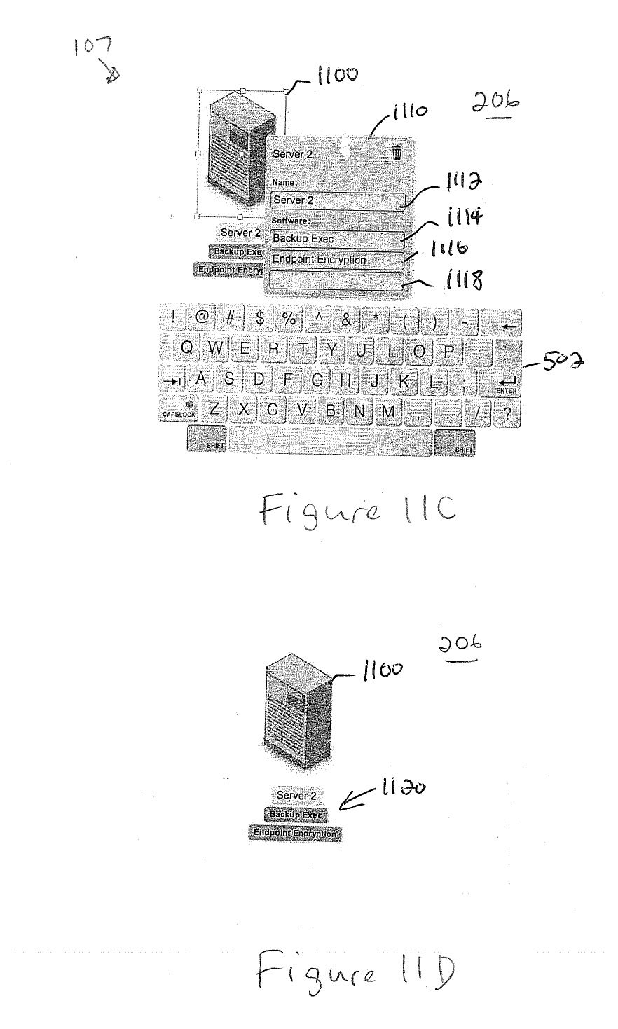

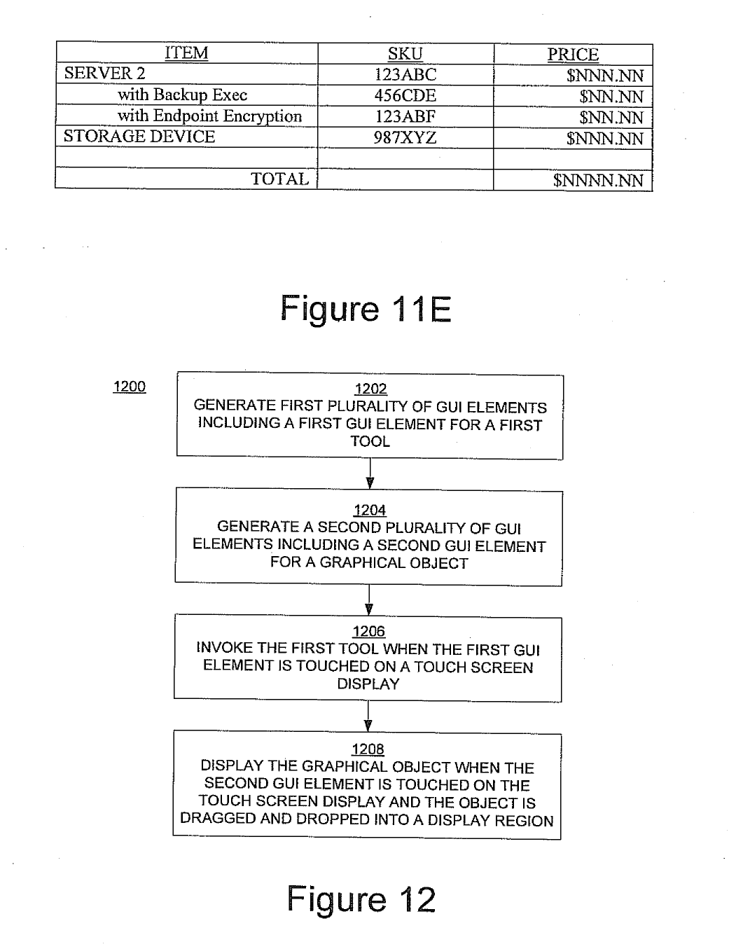

FIGS. 11A, 11B, 11C, and 11D illustrate a graphical object labeling feature according to an embodiment of the present disclosure. In FIG. 11A, a user creates a label for graphical object 1100 by first selecting (touching or tapping) that object. Alternatively, a label making tool can be invoked. In response to the user's action, label panel 1110 and virtual keyboard 502 are automatically displayed. In one embodiment, label panel 1110 includes first text field 1112 and second text field 1114. Using virtual keyboard 502, the user can enter text into first text field 1112. In one embodiment, first text field 1112 is initially populated with a default name (e.g., “Server 2”) for graphical object 1100; in such an embodiment, the text entered by the user replaces the default text. After entering information into first text field 1112, the user can select (touch) second text field 1114 and then can start to enter text into that field.

In one embodiment, once the user starts to enter text into second text field 1114, one or more default entries are displayed to the user based on the character(s) typed by the user. For example, after typing the letter “B,” the digital whiteboard program will display labeling information (a guess or suggestion) that both starts with that letter and is relevant to the default name for graphical object 1100. In other words, in the example of FIG. 11, the program will suggest labels that begin with “B” and are associated with “Server 2.” As shown in FIG. 11B, the user can complete second text field 1114 by selecting the program's guess, either by touching the label or by touching the virtual enter key on virtual keyboard 502, or the user can continue to enter a label of his or her choice using the virtual keyboard.

Furthermore, as shown in FIG. 11B, in response to text being entered into second text field 1114, third text field 1116 is displayed in anticipation of the user perhaps needing an additional field. With reference to FIG. 11C, if text is entered into third text field 1116, then fourth text field 1118 is displayed, and so on.

When the user is finished entering information into label panel 1110, the user can touch a position in display region 206 that is not occupied by a graphical object. Accordingly, virtual keyboard 502 and label panel 1110 are removed, and labels 1120 are associated with graphical object 1100, as shown in FIG. 11D.

With reference to FIG. 11E, the label information can be used to generate a text-based version of the graphical objects shown in a digital whiteboard presentation. For example, the information in labels 1120 (FIG. 11D) can be presented as a list under another tab of the digital whiteboard (tabs are shown in FIG. 2). Other information can be included in the list. For example, price information or a SKU (stock-keeping unit) for each item in the list can be retrieved from memory and included in the list. In essence, an invoice or purchase order, for example, can be automatically generated based on the information included in the digital whiteboard presentation and additional, related information retrieved from memory.

FIG. 12 illustrates a flowchart 1200 of a computer-implemented method for implementing a GUI according to embodiments of the present disclosure. Flowchart 1200 can be implemented as computer-executable instructions residing on some form of computer-readable storage medium (e.g., using computing system 100 of FIG. 1A).

In block 1202, a first plurality of GUI elements, including a first GUI element associated with a first tool, is generated on a touch screen display mounted on the computing system.

In block 1204, a second plurality of GUI elements, including a second GUI element associated with a graphical object on the touch screen display, is generated.

In block 1206, the first tool is invoked when selection of the first GUI element is sensed by the touch screen display.

In block 1208, the graphical object is displayed in the display region when selection of the second GUI element is sensed by the touch screen display and the graphical object is dragged-and-dropped to a position within the display region.

In summary, a digital whiteboard having some or all of the features described above can be used to create on the fly presentations that are easy to read and follow, can be easily captured (saved), can capture meeting content accurately and completely, can be effectively and readily shared, and are easy to iterate on, either during the initial meeting or at a later time. In addition to facilitating meetings and classroom activities, a digital whiteboard can be used for activities related to, but not limited to, Web page design, architectural design, landscape design, and medical applications. In the medical arena, for instance, an x-ray can be imported in the digital whiteboard, manipulated and labeled, and then saved.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered as examples because different architectures can be implemented to achieve the same functionality.

The process parameters and sequence of steps described and/or illustrated herein are given by way of example only. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. These software modules may configure a computing system to perform one or more of the example embodiments disclosed herein. One or more of the software modules disclosed herein may be implemented in a cloud computing environment. Cloud computing environments may provide various services and applications via the Internet. These cloud-based services (e.g., software as a service, platform as a service, infrastructure as a service, etc.) may be accessible through a Web browser or other remote interface. Various functions described herein may be provided through a remote desktop environment or any other cloud-based computing environment.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as may be suited to the particular use contemplated.

Embodiments according to the invention are thus described. While the present disclosure has been described in particular embodiments, it should be appreciated that the invention should not be construed as limited by such embodiments, but rather construed according to the below claims.

What is claimed is:

1. An apparatus comprising:
a computing system comprising a processor and memory within a housing; and
a touch screen display mounted on said housing and operable for sensing and communicating user inputs to said computing system, wherein said touch screen display is operable for displaying a graphical user interface (GUI) for a computer graphics program, said GUI comprising:
a display region;
a first plurality of GUI elements comprising a first GUI element associated with a first tool, wherein said first tool is invoked when selection of said first GUI element is sensed by said touch screen display; and
a second plurality of GUI elements comprising a second GUI element associated with a graphical object, wherein said graphical object is displayed in said display region when selection of said second GUI element is sensed by said touch screen display and said graphical object is dragged-and-dropped to a position within said display region.

2. The apparatus of claim 1 wherein said first tool is operable for performing an operation selected from the group consisting of: select; draw line; draw straight line; erase; create text; copy; paste; duplicate; group; ungroup; show grid; snap to grid; undo; redo; clear; scale; export image; save in an existing file; save as a new file; and open a file.

3. The apparatus of claim 1 wherein said first tool comprises a create text tool, wherein invoking said create text tool causes a virtual keyboard to be displayed automatically on said touch screen display.

4. The apparatus of claim 1 wherein said first tool comprises a draw line tool, wherein graphical objects created between the time said draw line tool is toggled on then off are automatically grouped as a single graphical object.

5. The apparatus of claim 1 wherein said computer graphics program is operable for automatically switching from said first tool to a different tool in response to an operation selected from the group consisting of: sensing a selection of a GUI element in said second plurality of GUI elements; and sensing a user input in said display region at a position that is not inside any graphical object.

6. The apparatus of claim 1 further comprising a third GUI element associated with a second tool for said computer graphics program, wherein said second tool is operable for affecting a property of said graphical object, and wherein said second tool is invoked when selection of said third GUI element and said graphical object are sensed via said touch screen display.

7. The apparatus of claim 6 wherein said property is selected from the group consisting of: line thickness; line color; type of line end; font size; text style; text alignment; size of text box; type of border for text box; type of background for text box; grid size; brightness; object name; and object software.

8. The apparatus of claim 1 wherein a first text field and a second text field are displayed on said touch screen display when selection of said graphical object is sensed by said touch screen display, wherein further a virtual keyboard is displayed automatically on said touch screen display when selection of said first text field is sensed via said touch screen display.

9. The apparatus of claim 8 wherein a third text field is displayed automatically on said touch screen display once a character is entered into said second text field.

10. The apparatus of claim 8 wherein said first text field includes default text that is automatically entered when said first field text field is generated, wherein said default text is replaceable with text entered via said virtual keyboard.

11. The apparatus of claim 1 wherein said second plurality of GUI elements is customizable by adding and removing selected GUI elements.

12. The apparatus of claim 11 wherein said second plurality of GUI elements comprises a subset of a superset of GUI elements, wherein said superset of GUI elements is customizable by importing GUI elements.

13. The apparatus of claim 1 wherein graphical objects displayed in said display region are identified by labels, wherein said computer graphics program is operable for automatically generating a text-based version of said graphical objects comprising a list of said labels and additional information selected from the group consisting of: a price associated with each of said graphical objects; and a SKU (stock-keeping unit) associated with each of said graphical objects.

14. The apparatus of claim 1 wherein said touch screen display is a multi-touch touch screen display, wherein an action is invoked in response to said touch screen display sensing contact at multiple points concurrently, and wherein said action is selected from the group consisting of: scrolling; pinch zoom; zoom in; and zoom out.

15. The apparatus of claim 1 wherein said second plurality of GUI elements relate to components of product lines particular to an enterprise.

16. A non-transitory computer-readable storage medium having computer-executable instructions that, when executed, cause a computing system to perform a method of implementing a graphical user interface (GUI) for a computer graphics program, said method comprising:
generating a first plurality of GUI elements on a touch screen display mounted on said computing system, said first plurality comprising a first GUI element associated with a first tool;
generating a second plurality of GUI elements on said touch screen display, said second plurality comprising a second GUI element associated with a graphical object;
invoking said first tool when selection of said first GUI element is sensed by said touch screen display; and
displaying said graphical object in said display region when selection of said second GUI element is sensed by said touch screen display and said graphical object is dragged-and-dropped to a position within said display region.

17. The computer-readable storage medium of claim 16 wherein said method further comprises displaying a virtual keyboard on said touch screen display.

18. The computer-readable storage medium of claim 16 wherein said method further comprises automatically switching from said first tool to a different tool in response to an operation selected from the group consisting of: sensing a selection of a GUI element in said second plurality of GUI elements; and sensing a user input in said display region at a position that is not inside any graphical object.

19. The computer-readable storage medium of claim 16 wherein said method further comprises:
displaying a first text field and a second text field on said touch screen display when selection of said graphical object is sensed by said touch screen display; and
displaying a virtual keyboard on said touch screen display when selection of said first text field is sensed via said touch screen display.

20. The computer-readable storage medium of claim 16 wherein graphical objects displayed in said display region are identified by labels, wherein said method further comprises generating a text-based version of said graphical objects comprising a list of said labels and additional information selected from the group consisting of: a price associated with each of said graphical objects; and a SKU (stock-keeping unit) associated with each of said graphical objects.

21. A tablet computer system comprising:
a touch screen display mounted on a surface of said computer system;
a processor coupled to said touch screen display; and
memory coupled to said processor, said memory having stored therein instructions that, when executed, cause said computer system to perform a method of implementing a graphical user interface (GUI) for a computer graphics program, said method comprising:
generating a first plurality of GUI elements on said touch screen display, said first plurality comprising a first GUI element associated with a first tool;
generating a second plurality of GUI elements on said touch screen display, said second plurality comprising a second GUI element associated with a graphical object;
invoking said first tool when selection of said first GUI element is sensed by said touch screen display; and
displaying said graphical object in said display region when selection of said second GUI element is sensed by said touch screen display and said graphical object is dragged-and-dropped to a position within said display region.

22. The computer system of claim 21 wherein said method further comprises displaying a virtual keyboard on said touch screen display.

23. The computer system of claim 21 wherein said method further comprises automatically switching from said first tool to a different tool in response to an operation selected from the group consisting of: sensing a selection of a GUI element in said second plurality of GUI elements; and sensing a user input in said display region at a position that is not inside any graphical object.

24. The computer system of claim 21 wherein said method further comprises:
displaying a first text field and a second text field on said touch screen display when selection of said graphical object is sensed by said touch screen display; and
displaying a virtual keyboard on said touch screen display when selection of said first text field is sensed via said touch screen display.

25. The computer system of claim 21 wherein graphical objects displayed in said display region are identified by labels, wherein said method further comprises generating a text-based version of said graphical objects comprising a list of said labels and additional information selected from the group consisting of: a price associated with each of said graphical objects; and a SKU (stock-keeping unit) associated with each of said graphical objects.
